(19) United States
(12) Patent Application Publication
(10) Pub. No.: US 2003/0185432 A1
(43) Pub. Date: Oct. 2, 2003

(54) Method and system for image registration based on hierarchical object modeling

(76) Inventors: DeZhong Hong, Singapore (SG); Chiat Pin Tay, Singapore (SG)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/371,312

(22) Filed: Feb. 20, 2003

Related U.S. Application Data
(60) Provisional application No. 60/368,879, filed on Mar. 29, 2002.

(51) Int. Cl. G06K 9/00

(52) U.S. Cl. 382/151

(57) ABSTRACT

A method and system are disclosed for image registration based on hierarchical object modeling. Objects from an image are extracted. Each object is extracted based on at least one characteristic of the object. A hierarchical object tree is generated using the extracted objects based on the characteristics of the objects. An image registration map is defined based on the hierarchical object tree. The image registration map identifies each object of the hierarchical object tree in the image.

RELATED APPLICATIONS

This application claims priority to U.S. Provisional Application No. 60/368,879, entitled “SEMICONDUCTOR INSPECTION SYSTEM AND METHOD,” filed on Mar. 29, 2002. This application is also related to U.S. patent application Ser. No. ______, entitled “METHOD AND SYSTEM FOR GOLDEN TEMPLATE IMAGE EXTRACTION,” filed on ______, which is hereby incorporated herein by reference and commonly owned by the same assignee of this application.

### FIELD

This invention relates generally to computer vision inspection systems for inspecting devices such as, for example, integrated circuit (IC) and printed circuit board (PCB) devices, and, more particularly, to a method and system for image registration based on hierarchical object modeling.

### BACKGROUND

Golden template comparison is a common technique for vision inspection systems to detect flaws and defects in images of devices such as IC devices and PCB devices using a golden template image. For instance, features in test images of the devices can be compared with features in the golden template image to determine flaws and defects. The golden template image can thus provide an ideal reference image for a device being inspected, for example, indicating ideal physical features of the device such as the ideal size for “contact leads” or “product markings” for the device.

Typically, before performing vision inspection, the golden template image is registered. The registration process requires identifying objects in the image to form a template. The template is overlaid on test images of devices to determine flaws and defects on the devices by comparing identified objects with objects in the test images. In prior systems, objects in the golden template image were obtained from an image of a “sample golden unit.” The sample golden unit is an ideal device having minimal flaws or defects. One disadvantage of these systems is that it is difficult to find a good sample golden unit with minimal flaws or defects to obtain the golden template image. Thus, registration of objects in a golden template image becomes difficult if based on a sample golden unit.

Another disadvantage of prior systems, when performing the golden template image extraction process, is that prior systems do not deal with noise, distortion, or other sample unit image defects introduced by cameras or frame grabbers used for obtaining the sample golden unit image. Furthermore, because not all features of the unit may be of interest, in prior systems, a user may be required to input the description for each feature of interest, which is an inefficient manner of generating the golden template image. This also makes the registration of objects in the golden template image inefficient and difficult.

There exists, therefore, a need for an improved method and system for image registration, which can overcome the disadvantages of prior systems.

### SUMMARY

According to one aspect of the invention, a method is disclosed for image registration. Objects from an image are extracted. Each object is extracted based on at least one characteristic of the object. A hierarchical object tree is generated using the extracted objects based on the characteristics of the objects. An image registration map is defined based on the hierarchical object tree. The image registration map identifies each object of the hierarchical object tree in the image.

According to another aspect of the invention, an image processing system is disclosed for image registration. The image processing system comprises a processor coupled to an imaging device. The imaging device obtains an image having a plurality of objects. The processor extracts the objects based on at least one characteristic for each object. The processor also generates a hierarchical object tree using the extracted objects based on the characteristics of the objects, and defines an image registration map based on the hierarchical object tree. The image registration map identifies each object of the hierarchical object tree in the image.

Other features and advantages will be apparent from the accompanying drawings, and from the detailed description, which follows below.

### BRIEF DESCRIPTION OF THE DRAWINGS

The accompanying drawings, which are incorporated in, and constitute a part of this specification illustrate exemplary embodiments and implementations and, together with the description, serve to explain the principles of the invention. In the drawings,

FIG. 1 illustrates an exemplary block diagram of an image processing system to implement techniques in accordance with the invention;

FIG. 2 illustrates a basic flow diagram of a method for image registration;

FIG. 3 illustrates a flow diagram of a method for processing objects in an image to generate a hierarchical object tree;

FIG. 4A illustrates an exemplary image with identified objects in an image;

FIG. 4B illustrates an exemplary object tree using the objects identified in the image of FIG. 4A;

FIGS. 5A through 5D illustrate exemplary images of objects for image registration;

FIG. 6 illustrates a flow diagram of a method for registering an image reference point;

FIG. 7A illustrates an exemplary image for determining a reference point by two lines;

FIG. 7B illustrates an exemplary image for determining a reference point by two points;

FIG. 8 illustrates a flow diagram of a method for generating an image registration map using a hierarchical object tree;

FIGS. 9 through 12 illustrate exemplary images for generating an image registration map; and

FIG. 13 illustrates a flow diagram of a method for generating a rotated image registration map.

### DETAILED DESCRIPTION

Reference will now be made in detail to embodiments and implementations, examples of which are illustrated in the accompanying drawings. Wherever possible, the same reference numbers will be used throughout the drawings to refer to the same or like parts.

A. Overview

Image processing techniques in accordance with the present invention are disclosed that provide a simple way of image registration. In one implementation, objects from an image are extracted. Each object is extracted based on at least one characteristic of the object. A hierarchical object tree is generated using the extracted objects based on the characteristics of the objects. An image registration map is defined based on the hierarchical object tree. The image registration map identifies each object of the hierarchical object tree in the image. The image can be a golden template image. In this manner, by using the hierarchical object tree, a simple manner of defining and identifying objects for a golden template image can be achieved.

In the following description, a “registration image” or “registration image map” refers to an image including a map of defined and identified objects in the image. The image can be a golden template image having defined and identified objects in the image. The objects can be defined and identified using a hierarchical object tree, as described in further detail below. Thus, in the following description, the process of “image registration” refers to extracting objects from an image and defining and identifying the extracted objects. Additionally, a registration image or registration image map provides a template to compare objects in a golden template image with objects in test images of devices to detect flaws or defects on the devices.

The following implementations can extract objects that ignore undesirable flaws or defects in an image. In this manner, objects can be extracted from the image based on a non-golden sample unit (having flaws or defects) or a golden sample unit (having minimal flaws or defects). Furthermore, a user can define characteristics for extracting the objects, which prevents undesirable content of objects from being extracted. Thus, a registration image or registration image map can be generated using a hierarchical object tree to define and identify objects in a golden template image, which can be derived from a non-golden sample unit or a sample golden unit.

B. Image System Overview

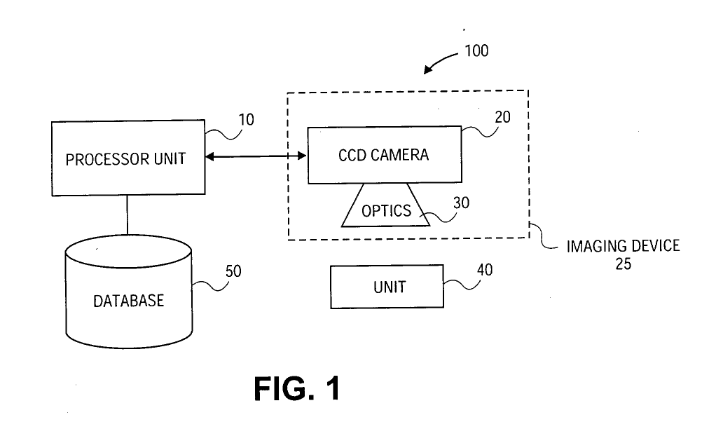

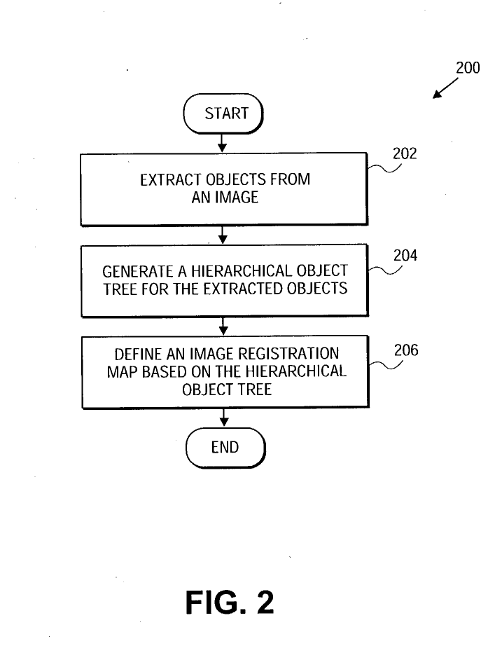

FIG. 1 illustrates an exemplary block diagram of an image processing system 100 to implement techniques in accordance with the invention. For example, image processing system 100 can be configured to implement the methods described in FIGS. 2, 3, 6, 8, and 13 below. Image processing system 100 includes a processor 10 coupled to an imaging device 25. In this example, imaging device 25 includes a charge coupled device (CCD) camera 20 having optics 30 for obtaining images of a unit 40. Alternatively, other types of imaging devices or frame grabbers can be used for obtaining images of unit 40. Optics 30 can include CCD camera components or any number of optical components that includes one or more lenses to obtain an image from unit 40.

The obtained image can be converted into a binary bit map for image processing. The converted image can be a raw image or a gray scale image having intensity levels ranging from 0 to 255. The converted image can be used for obtaining a “registration image” or a “registration image map,” as described in further detail below.

Coupled to processor 10 is a database storage 50 for storing image data, e.g., registration images or test images of inspected devices or units. Examples of storage 50 include a hard disk drive, a digital video drive, an analog tape drive, random access memory (RAM) devices, flash memory devices, or other like storage devices. Image data for image processing system 100 can also be stored in remote locations for access by processor 10 via a network (not shown). Processor 10 can be included within a general purpose computing device such as, for example, a workstation for processing images of unit 40 obtained by imaging device 25 via optics 30. Processor 10 can perform the techniques disclosed herein using any number of devices including memory devices and central processing units (CPUs). For example, software modules or instructions can be stored in one or more memory devices and executed by a CPU in order to implement the methods described below.

Additionally, other components (not shown) can be coupled with processing unit 10 such as a display device and a keyboard input device for performing image registration or other image processing functions. Unit 40 can be a sample unit in which frame grabber 20 and optics 30 obtain an image of unit 40 for extracting a golden template image and for registering the golden template image. Alternatively, unit 40 can be a device or unit for inspection in which features from an image of the unit 40 are compared with features from a registered golden template image (registration image or registration image map) stored in storage 50 for detecting flaws and defects on unit 40. Unit 40 can be a non-golden sample unit or a golden sample unit.

C. Image Registration Techniques

FIG. 2 illustrates a basic flow diagram of a method 200 for image registration. The following method generates an image registration map by extracting and identifying objects hierarchically from an image such as, for example, a golden template image based on characteristics of the objects. The image registration map can provide a “template” that is compared with test images of devices to detect flaws or defects on the devices.

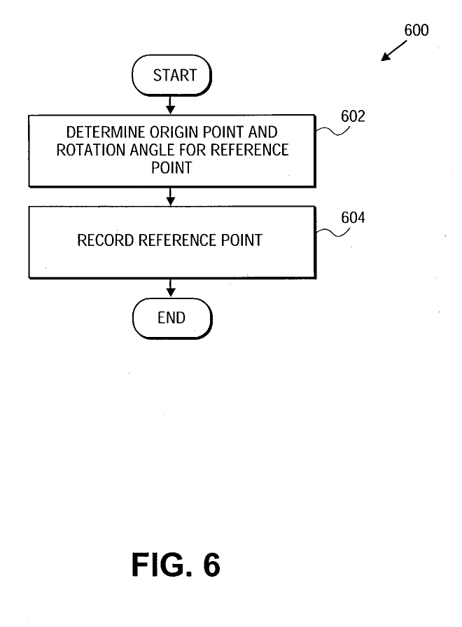

Initially, a plurality objects from an image are extracted (step 202). The objects can be extracted automatically or manually based on at least one characteristic that each object possesses as described in further detail regarding FIG. 6. For instance, pixels in the image related to objects matching specified characteristics can be extracted. The image for extracting the objects can be a golden template image or a raw image.

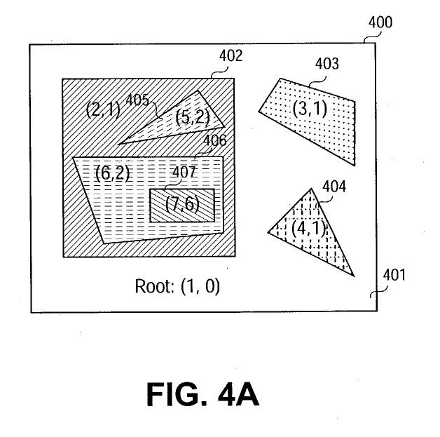

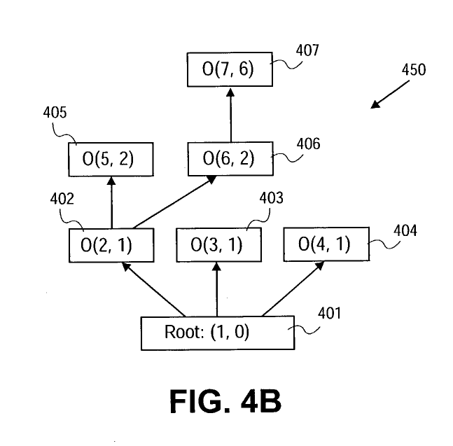

Each object refers to a region of the image (“object region”). For example, referring to FIG. 4A, the objects 401 through 407 can be extracted from the image 400. The object region for each object possesses characteristics and features including color features, texture features, edge features, and other like features. Each object can thus be defined by multiple features, and expressed by an array of feature vectors V[n] where n is the number of features for the object. For example, an IC device can have a plurality of “ball connections” and “code markings” on its cover. Each of the connections and markings can represent a characteristic for the IC device. Thus, the IC device can have a plurality of characteristics i and be expressed by a plurality of feature vectors for each characteristic as V[i]={f₁, f₂, . . , fₘ}. Each characteristic can have a total of m feature vectors, wherein, e.g., feature vector f₁may represent a color feature vector, feature vector f₂ may represent a texture feature vector, and feature vector f₃ may represent an edge feature vector, and so on.

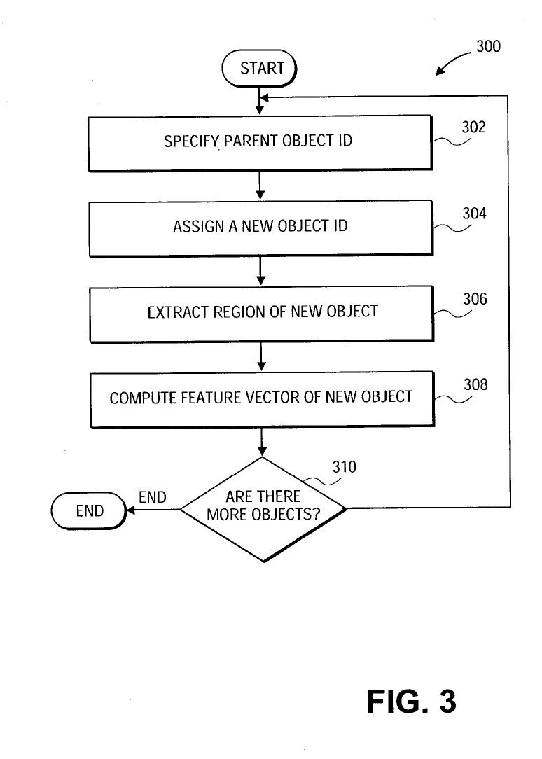

Next, a hierarchical object tree is generated for the extracted objects based on the characteristics of the objects (step 204). Generating the hierarchical object tree is described in further detail regarding FIG. 3. Objects in the hierarchical object tree can be defined and identified by an identifier (ID). For example, referring to FIG. 4B, a hierarchical object tree 450 includes a root or parent object 401 with a plurality of leaf or child objects 402 through 407. The parent object 401 is defined and identified as “Root:(1,0)” and the child objects 402 through 407 are defined and identified as “O(2,1)”, “O(3,1)”, “O(4,1)”, “O(5,2)”, “O(6,2)”, and “O(7,6)”. Any type of alpha-numeric ID can be assigned to the parent and child objects. The parent object 401 can be the background of the image or a background object. In this example, the hierarchical object tree 450 includes a single parent object 401. Each child object can have one or more other child objects. For example, child object 402 is the parent object for child objects 405 and 406. Hierarchical object tree 450 thus includes a plurality child objects 402 through 407 based from a single parent object 401.

Lastly, using the hierarchical object tree, an image registration map is defined (step 206). For example, objects 401 through 407 can be defined and identified, as shown in FIG. 4A, in image 400. Thus, image 400 can be a golden template image with defined and identified objects. Parent object 401 and child objects 402 through 407 can be linked together as shown in the hierarchical object tree 450 of FIG. 4B. By using the hierarchical object tree 450, the process of image registration can be more efficient and provides a simple manner of defining and identifying objects (e.g., objects 401 through 407) in image 400. This image can thus be registered to provide a registration image or a registration image map, which can provide a template for comparing with test images of devices.

FIG. 3 illustrates a flow diagram of a method 300 for generating a hierarchical object tree (e.g., hierarchical object tree 450). Initially, a parent object ID is specified, which represents the parent object, and is used to build a new object (step 302). The new object can be expressed as {ID, PID, V[n]}, where “ID” represents the new object, “PID” represents its parent object, and V[n] represents feature vectors for the new object.

Referring to FIG. 4A, a user can specify the background of image 400 as a new object 401 and provide the object ID=1. Because there is no parent object for this object, it is taken as the root object, which is expressed as {Root:(1,0)} where “1” refers it its ID, “0” refers to its PID, and “0” means that there is no parent object for this object. Based on one defined parent object 401, child objects 402 through 407 can be defined as described below.

Next, a new object ID is assigned for a new object (step 304). The new object ID can be expressed as {O(Object ID, Parent ID)} where “O” refers to the object, “Object ID” represents the object ID, and “Parent ID” represents the ID of its parent object. For example, based on the ID of parent object 401, the object IDs for child objects 402 through 407 can be defined and identified. A child object can also be a parent object for other child objects. For instance, child object 402 is the parent object for child objects 405 and 406. These child objects are identified as “O(5,2)” and “O(6,2)”, respectively, wherein “2” represents its parent object ID or the object ID for object 402. Thus, based on a defined or identified parent object, any number of child objects can be defined or identified. Furthermore, the child objects can be identified automatically by incrementing the ID numbers for each object and maintaining its parent object ID. For example, child objects 402, 403, and 404 can be assigned incrementing ID numbers such as “2 ”, “3”, and “4”, respectively. If, for example, the new object is child object 402 it is identified with its assigned object ID “O(2,1)”.

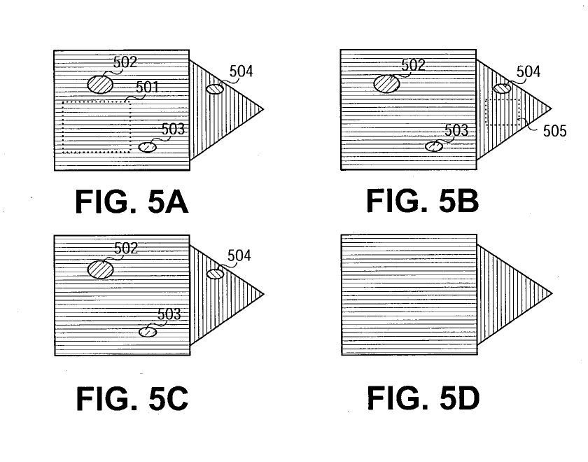

The region of the new object is then extracted (step 306). The new object can be extracted based on at least one characteristic or feature that each object possesses. For instance, this step requires “object teaching” that requires a user to input knowledge such as, for example, a color feature, texture feature, shape feature, or other like feature for the object region in order to extract the object. The process of extracting the object can be implemented automatically or manually. For automatic object extraction, a user selects one or more areas of an object region. For example, referring to FIGS. 5A and 5B, a user can select an area 501 to extract the square object region or select an area 505 to extract the triangle object region using a region growing algorithm as described in co-pending and commonly assigned U.S. patent application Ser. No. ______, entitled “METHOD AND SYSTEM FOR GOLDEN TEMPLATE IMAGE EXTRACTION,” filed on ______.

In this manner, an object or object region can be extracted that ignores noises, e.g., holes 501-504, in the image as shown in FIG. 5D. Thus, the final image can provide ideal pixels for objects in an image. For manual object extraction, a user outlines the object or region to be extracted and specifies the characteristics for extracting the object or region. For instance, the user inputs feature vectors V[n] for each characteristic of the object such that pixels in the image matching the feature vectors are included in the extracted object or region. In this manner, a user can extract each object manually. The non-object parts can also be defined such that the feature vectors of the object can be computed completely.

Next, a feature vector V[n] of the new object is computed for the new object (step 308). The feature vector V[n] for each object defines and represents the characteristics for the object. The feature vector V[n] can be computed for each object in an image. If each object has distinct ranges and characteristics for its feature vector V[n], the child objects 402 through 407 in image 400 can be easily extracted by specifying a contrast threshold between the parent object 401 and the child objects 402 through 477. By comparing with the feature vector V[n] for an object, the defects and flaws on the object, which have distinct ranges of their feature vectors from the object, can be easily detected. Otherwise, the objects can only be extracted manually by the user. This is useful for detecting flaws and defects of objects in test images of devices or units under inspection.

A check is then made to determine if there are more objects (step 310). If there are more objects, the method 300 continues back to step 302 to process all objects in the image. If there are no more objects, the method 300 ends. In this manner, each child object can be assigned an identifier. The above method 300 can define m objects Oⱼ{IDⱼ, PIDⱼ, Vⱼ[n]} to form a hierarchical object tree, e.g., hierarchical object tree 450. The hierarchical object tree can be registered by forming a linked list of defined and identified objects that can be expressed as Tlist{O₁, O₂, . . . , Oₘ}, where there can be m objects in the hierarchical object tree. The relations between the objects can be traced by the object IDⱼ and the parent object PIDⱼ. For example, the child object 406 is identified as O(6,2) having a child object ID “6”. Thus, in order to determine the number of child objects defined on the parent object PID “2”, each child object ID must be recorded, e.g., O(5,2) and O(6,2) in connection with parent object ID “2”.

FIG. 6 illustrates a flow diagram of a method 600 for registering an image reference point. Registration of an image reference point is necessary to analyze test images of devices that have shifted or rotated during inspection. The reference point can be used to rotate a registration image or registration image map to compare with test images of rotated devices.

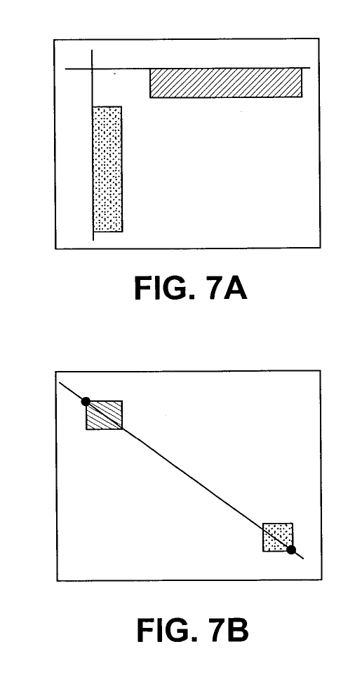

Initially, an origin point (op) and a rotation angle R {Pₒₚ, θ)} are determined for the reference point (step 602). In one implementation, referring to FIG. 7A, the origin point and rotation angle can be determined by using two lines that intersect, i.e., the two lines are not in parallel. The two lines can be rigid and fixed that corresponds to features of a device in an image. The two lines can be detected using a line detection algorithm such as the Hough transform algorithm. The origin point will thus be the intersection point of the two lines, and the rotation angle is the angle between one of the lines and an axis, e.g., the X+ axis.

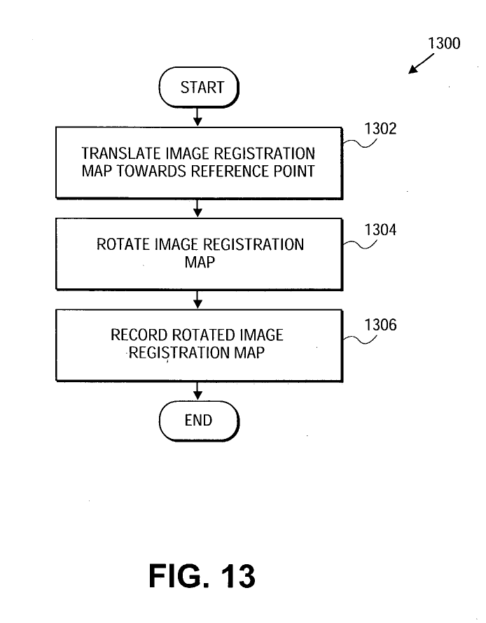

In another implementation, referring to FIG. 7B, the origin point and rotation angle can be determined by using two different points. The two points can be rigid and fixed in position. The two points can be detected using standard algorithms for edge or comer detection. One of the points is considered the origin point, and the rotation angle can be the angle between the line formed by the two points and an axis such as the X+ axis. After the origin point and rotation angle are determined, the reference point R{Pₒₚ, θ} is recorded (step 604). Thus, an image registration map can include the recorded reference point. This can be used to translate and rotate an image registration map to compare with test image of devices that have rotated during inspection as described in further detail in FIG. 13.

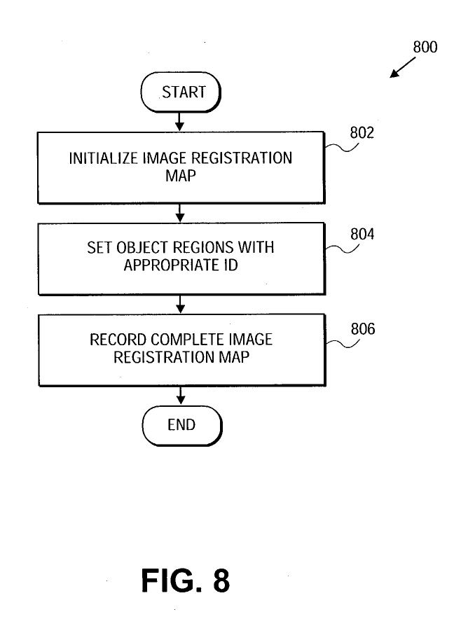

FIG. 8 illustrates a flow diagram of a method 800 for generating an image registration map using a hierarchical object tree. For example, referring to FIG. 4B, hierarchical object tree 450 can be used to generate the image registration map. Hierarchical object tree 405 can be defined by a link list Tlist{O₁, O₂, . . . Oₘ} for each object 401 through 407.

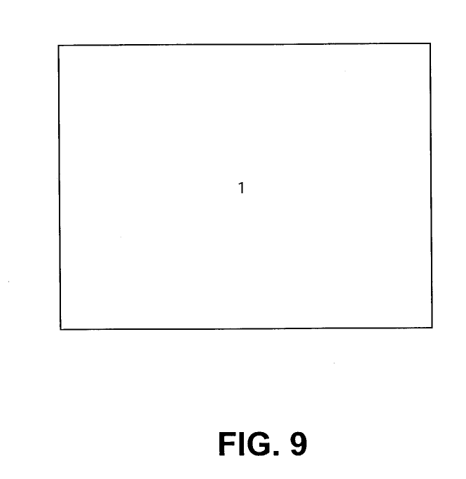

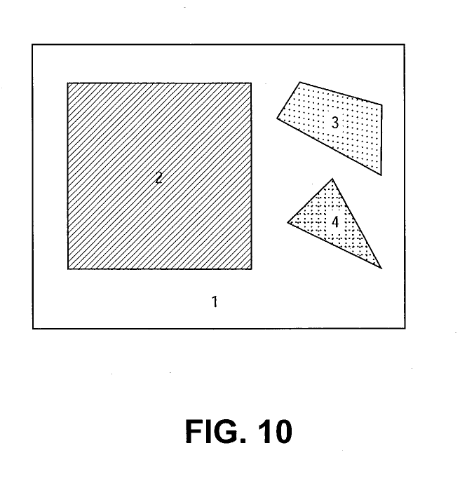

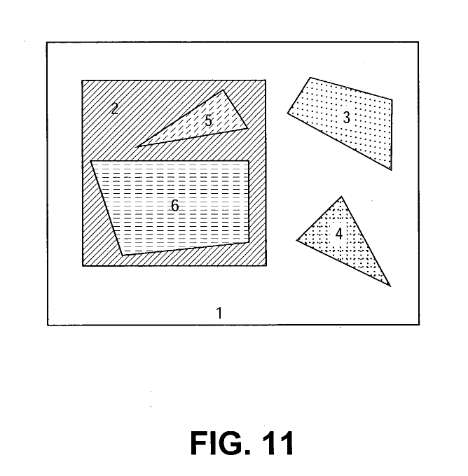

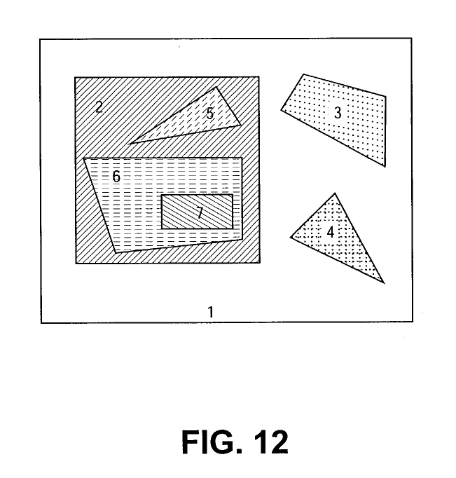

Initially, the image registration map is initialized (step 802). For example, referring to FIG. 9, the parent object or root object is initialized with an ID=1 for the image registration map. In this step, the background is labeled with the identifier “1” in the image. Next, referring to FIG. 10, child objects O(2,1), O(3,1) and O(4,1) based on the parent object with PID=1 and are defined and identified with IDs=2, 3, and 4, respectively. Furthermore, the regions in the image of these child objects are set with their IDs in the image registration map. Referring to FIG. 11, the child objects of child objects are then defined and identified. For example, child object O(2,1) includes other child objects O(5,2) and O(6,2) that have IDs=“5” and “6”, respectively and are labeled in the image registration map. Thus, object O(2,1) is the parent object for objects O(5,2) and O(6,2). Lastly, referring to FIG. 12, the complete image registration map is recorded by defining and identifying any other child objects from child objects (step 806). For example, the child object O(7,6) (having an ID=“7”) based on its parent object O(6,2) is defined and identified in the image registration map. Thus, the image registration map with defined and identified regions “1” through “7” are recorded based on the hierarchical object tree 450 for those objects.

FIG. 13 illustrates a flow diagram of a method 1300 for generating a rotated image registration map. The following method 1300 can be used to translate or rotate a registration image, as shown in FIG. 12, to compare with test images of devices that have rotated during inspection.

Initially, the image registration map is translated towards the reference point. R{Pₒₚ, θ}, as described in FIG. 6 (step 1302). For a rotated image registration map, the reference point can be expressed as R₁{P₁ₒₚ, θ₁}. Based on the rotation angle θ₁, a rotation angle index can be expressed as k₁. For each rotation angle index k₁, the image registration map can be chosen as

$${P}_{map}^{m} [ {k}_{1} ] .$$

. Before applying the image registration map to test images of devices that have rotated, the image registration map is translated towards the reference origin point R₁{P₁ₒₚ, θ₁} and can be expressed as:

$${P}_{t\_map} = {P}_{map}^{m} [ {k}_{1} ] + {P}_{t\_op}$$

Next, the image registration map is rotated (step 1304). The image registration map can be rotated back to the X+ axis based on P¹ _{Map} according to the reference angle θ, and the rotated image registration map can be expressed as:

$$\{ \begin{matrix}{P}_{map}^{m} x = {P}_{map}^{*} x * cos ( - θ ) - {P}_{map}^{m} y * sin ( - θ ) \\ {P}_{map}^{m} y = {P}_{map}^{*} x * sin ( - θ ) + {P}_{map}^{m} y * cos ( - θ )\end{matrix}$$

Because the inspection of devices is time critical, the rotation computation can be pre-computed and recorded. Furthermore, an array of rotation angles can be used for computing the rotated image registration maps. For example, the rotation angles θ can include angles having the values {−5, −4, −3, −2, −1, −0, 1, 2, 3, 4, 5}. Thus, an array of the image registration maps is computed based on P^{m}_{Map} according the array of rotation angles and be expressed as:

$$\{ \begin{matrix}{P}_{map}^{m} [ k ] x = {P}_{map}^{*} x * cos θ [ k ] - {P}_{map}^{m} y * sin θ [ k ] \\ {P}_{map}^{m} [ k ] y = {P}_{map}^{*} x * sin θ [ k ] + {P}_{map}^{m} y * cos θ [ k ]\end{matrix}$$

where k is the rotation angle index, and P^{m}_{Map}[k] is the final image registration map array with rotation angle index k.

Thus, a method and system for image registration based on hierarchical object modeling have been described. Furthermore, while there has been illustrated and described what are at present considered to be exemplary implementations and methods of the present invention, various changes and modifications can be made, and equivalents can be substituted for elements thereof, without departing from the true scope of the invention. In particular, modifications can be made to adapt a particular element, technique, or implementation to the teachings of the present invention without departing from the spirit of the invention.

What is claimed is:

1. A method for image registration, comprising:
extracting objects from an image, each object being extracted based on at least one characteristic of the object;
generating a hierarchical object tree for the extracted objects based on the characteristics of the objects; and
defining an image registration map based on the hierarchical object tree, the image registration map identifying each object of the hierarchical object tree in the image.

2. The method of claim 1, wherein the step of extracting the plurality of objects further comprises extracting the plurality of objects that ignores undesirable flaws and defects in the image.

3. The method of claim 1, wherein the step of generating the hierarchical object tree further comprises:
assigning identifiers to the objects in the image; and
linking the objects based on the assigned identifiers.

4. The method of claim 3, wherein the step of linking the objects further comprises linking a parent object with one or more child objects.

5. The method of claim 1, further comprising:
determining a reference point for the image registration map; and
generating an array of rotated image registration maps using the reference point and an array of rotation angles.

6. The method of claim 1, wherein the image is obtained from a non-golden sample unit or a sample golden unit.

7. The method of claim 1, wherein the characteristics of the objects are user-definable.

8. A image processing system, comprising:
an imaging device to obtain an image having a plurality of objects; and
a processor coupled to the imaging device, the processor extracting the objects from the image, each object being extracted based on at least one characteristic of the object, to form a hierarchical object tree using the extracted objects based on the characteristics of the objects, and to create an image registration map based on the hierarchical object tree, the image registration map identifying each object of the hierarchical object tree in the image.

9. The image processing system of claim 8, wherein the processor extracts the objects that ignores undesirable flaws and defects in the image.

10. The image processing system of claim 8, wherein the processor assigns identifiers to the objects in the image and links the objects based on the assigned identifiers.

11. The image processing system of claim 10, wherein the processor links a parent object with one or more child objects.

12. The image processing system of claim 8, wherein the processor determines a reference point for the image registration map and to generate an array of rotated image registration maps using the reference point and an array of rotation angles.

13. The image processing system of claim 8, wherein the image processing device obtains the image from a non-golden sample unit or a sample golden unit.

14. The image processing system of claim 8, wherein the characteristic of the objects are user-definable.

15. A computer-readable medium containing instructions, when if executed by a processing system, cause the processing system to perform a method comprising:
extracting a plurality objects from an image, each object being extracted based on at least one characteristic of the object;
forming a hierarchical object tree using the extracted objects based on the characteristics of the objects; and
defining an image registration map based on the hierarchical object tree, the image registration map identifying each object of the hierarchical object tree in the image.

16. The computer-readable medium of claim 15, wherein the instructions, when executed by the processing system, cause the processing system to perform a further step of:
extracting the plurality of objects that ignores undesirable flaws and defects in the image.

17. The computer-readable medium of claim 15, wherein the instructions, when executed by the processing system, cause the processing system to perform further steps of:
assigning identifiers to the objects in the image; and
linking the objects based on the assigned identifiers.

18. The computer-readable medium of claim 17, wherein the instructions, when executed by the processing system, cause the processing system to perform a further step of:
linking a parent object with one or more child objects.

19. The computer-readable medium of claim 15, wherein the instructions, when executed by the processing system, cause the processing system to perform further steps of:
determining a reference point for the image registration map; and
generating an array of rotated image registration maps using the reference point and an array of rotation angles.

20. The computer-readable medium of claim 16, wherein the instructions, when executed by the processing system, cause the processing system to perform a further step of:
obtaining the image from a non-golden sample unit or a sample golden unit.
